(19) United States
(12) Patent Application Publication
(10) Pub. No.: US 2019/0212971 A1
(43) Pub. Date: Jul. 11, 2019

(54) ACOUSTIC APPARATUS CONTROL OPERATION INPUT DEVICE AND ACOUSTIC APPARATUS CONTROL OPERATION INPUT PROGRAM

(71) Applicant: Pioneer DJ CORPORATION, Kanagawa (JP)

(72) Inventors: Hirokatsu Kawano, Yokohama-shi, Kanagawa (JP); Toshiki Nakai, Yokohama-shi, Kanagawa (JP); Junichiro Inoue, Yokohama-shi, Kanagawa (JP)

(73) Assignee: Pioneer DJ CORPORATION, Kanagawa (JP)

(21) Appl. No.: 16/316,162

(22) PCT Filed: Jul. 19, 2016
(86) PCT No.: PCT/JP2016/071177

§ 371 Date: Jan. 8, 2019

(51) Int. Cl. G06F 3/16; H04S 7/00; H04S 3/00

(52) U.S. Cl. CPC G06F 3/165; G06F 3/162; H04S 2400/15; H04S 7/40; H04S 3/008; H04S 7/30

(57) ABSTRACT

A sound equipment control operation input device includes: a plurality of operation units, at least one of the operation units being operated to control sound equipment; a control mode switcher configured to switch one or more of the operation units to a first control mode for controlling the sound equipment or a second control mode for controlling lighting equipment; a control mode determiner configured to determine respective control mode settings of the operation units; and a control mode visual indicator configured to visually indicate the respective control mode settings of the operation units based on results of determination by the control mode determiner.

### TECHNICAL FIELD

The present invention relates to a sound equipment control operation input device and a sound equipment control operation input program.

### BACKGROUND ART

A known conventional technique for a control operation input device configured to control a plurality of electronic devices is related to a learning remote control system where infrared codes outputted from the electronic devices are received so that a target electronic device being controlled is identified with reference to a memory (for instance, see Patent Literatures 1 and 2).

In a concert and a night club, it is important for stage effects to match lighting with a music piece or change lighting in synchronization with a music piece.

In order to obtain an accurate stage effect by matching lighting with a music piece, a dedicated lighting staff having a good understanding of the music piece desirably manipulates a lighting device. However, it is difficult in terms of costs and the like that the dedicated lighting staff constantly stays in a small-sized concert, night club, event and the like.

For the above reasons, some DJ performers, or users, wish to simultaneously control sound equipment and lighting equipment using a player and/or a mixer as described in Patent Literature 3 to achieve improved stage effects.

Accordingly, for instance, with use of switches and levers of the player and mixer, a user may switch between control of the sound equipment and control of the lighting equipment at a desired timing using predetermined one(s) of the switches and levers.

### CITATION LIST

### Patent Literature(s)

Patent Literature 1: JP 2015-103892 A
Patent Literature 2: JP 08-331666 A
Patent Literature 3: JP 2012-129977 A

### SUMMARY OF THE INVENTION

### Problem(s) to be Solved by the Invention

However, if the technique(s) of Patent Literature 1 and/or Patent Literature 2 is applied to the player and mixer of Patent Literature 3, the user could not identify which one of the sound equipment and the lighting equipment is to be controlled using the predetermined switch and/or lever of the player and/or mixer. Thus, the user would erroneously operate the switch and/or lever for controlling the lighting equipment contrary to his/her intent to control the sound equipment. In particular, such an erroneous operation is highly likely to be caused during a DJ performance, which is usually given in a dark place.

An object of the invention is to provide a sound equipment control operation input device and a sound equipment control operation input program that enable simultaneous control of sound equipment and lighting equipment without error.

### Means for Solving the Problem(s)

According to an aspect of the invention, a sound equipment control operation input device includes: a plurality of operation units, at least one of the operation units being operated to control sound equipment; a control mode switcher configured to switch one or more of the operation units to a first control mode for controlling the sound equipment or a second control mode for controlling lighting equipment; a control mode determiner configured to determine respective control mode settings of the operation units; and a control mode visual indicator configured to visually indicate the respective control mode settings of the operation units based on results of determination by the control mode determiner.

According to another aspect of the invention, a sound equipment control operation input program is configured to enable a computer to function as the sound equipment control operation input device.

### BRIEF DESCRIPTION OF DRAWING(S)

FIG. 1 schematically shows a sound-and-lighting control system according to an exemplary embodiment of the invention.

FIG. 2 is a front view showing a deck area and a mixer area of a sound equipment control operation input device of the sound-and-lighting control system according to the exemplary embodiment.

FIG. 3 is a functional block diagram showing the sound equipment control operation input device and a computer of the sound-and-lighting control system according to the exemplary embodiment.

FIG. 4 schematically shows a display state of the deck area after display change by a control mode visual indicator according to the exemplary embodiment.

FIG. 5 schematically shows another display state of the deck area after display change by the control mode visual indicator according to the exemplary embodiment.

FIG. 6 schematically shows an image showing a status of a control mode setting appearing on a state display according to the exemplary embodiment.

### DESCRIPTION OF EMBODIMENT(S)

### [1] Overall Configuration of Sound-and-Lighting Control System 1

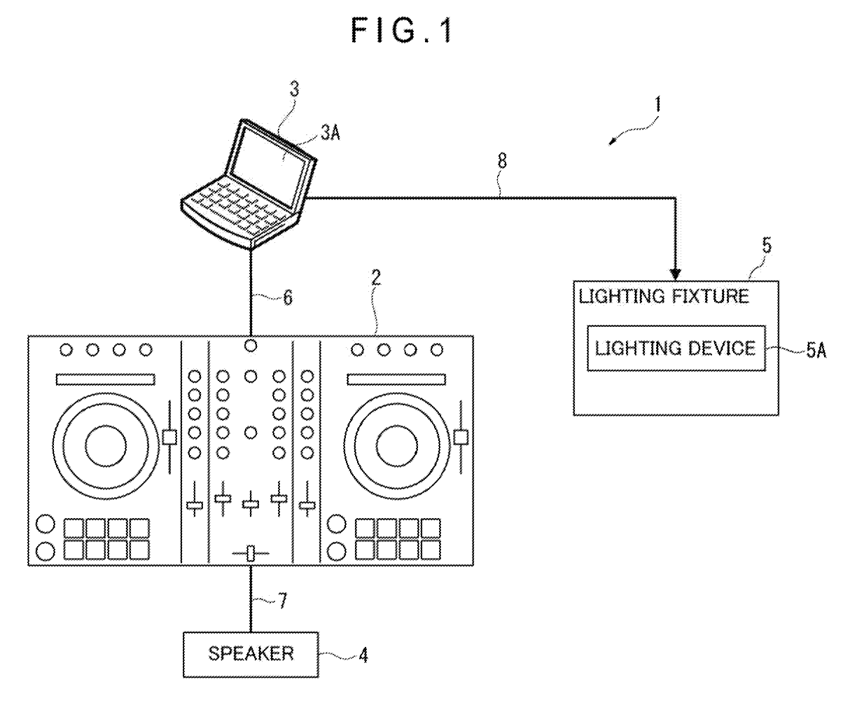

FIG. 1 schematically shows a sound-and-lighting control system 1 according to an exemplary embodiment of the invention. The sound-and-lighting control system 1, which is a system capable of simultaneously controlling sound equipment for a DJ performance and controlling lighting equipment along with the control of the sound equipment, includes a DJ controller 2 (sound equipment control operation input device), a computer 3, a speaker 4, and a lighting fixture 5.

The DJ controller 2, which is a main component of the DJ equipment that is to be operated by a user, is connected to the computer 3 through a communication cable 6.

The DJ controller 2 is also connected to the speaker 4 through an analog cable 7.

The computer 3 adds a sound effect, which corresponds to an reproduction control operation inputted to the DJ controller 2, to music piece data recorded on an optical disc inserted in the DJ controller 2 or music piece data stored in the computer 3 based on a control operation signal for the sound equipment outputted when a user operates the DJ controller 2, and outputs the data to the DJ controller 2 so that sound corresponding to the user's operation is outputted from the speaker 4 through the analog cable 7.

The computer 3 is also connected to the lighting fixture 5 thorough a communication cable 8.

The lighting fixture 5, which provides lighting in a live-performance space and an event space, includes various lighting devices 5A frequently used as live-performance equipment.

Examples of the lighting devices 5A (lighting equipment) include a bar light, an electronic flash, and a moving head, which are frequently used for stage lighting. For each of the lighting devices 5A, parameters such as on and off of the lighting, brightness thereof, and, depending on the lighting device, an irradiation direction and a moving speed of the lighting device can be specified.

In order to control the above parameters, the lighting devices 5A of the lighting fixture 5, which comply with the DMX512 regulation, are connected to each other in accordance with the DMX512 regulation and lighting control signals complying with the DMX512 regulation are sent to the lighting devices 5A to allow the lighting devices 5A to provide a desired lighting.

It should be noted that although the DMX512 regulation is the common regulation in the field of stage lighting, the computer 3 and the lighting fixture 5 may be connected in compliance with any other regulation.

### [2] Configuration of DJ Controller 2

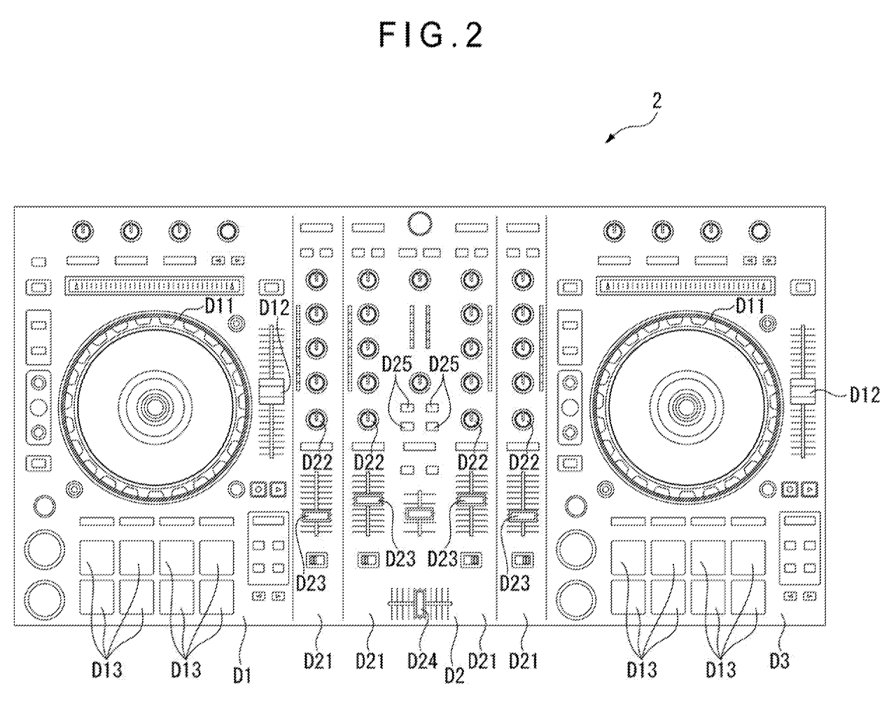

FIG. 2 is a plan view of the DJ controller 2. The DJ controller 2 is defined into two deck areas D1, D3 and a mixer area D2.

Here, the term “deck area” according to the invention mainly means an area for operating a device configured to implement a reproduction control function for a reproduction signal and examples of the “device configured to implement a reproduction function for a reproduction signal” include a DJ player and a DJ effector. These areas are not necessarily implemented as hardware being mounted but may be implemented as an application program (software). The deck areas D1, D3 and the mixer area D2 may each be divided into any possible number of parts.

The “reproduction signal” may be in the form of sound signal or image signal. In some exemplary embodiments, sound signals are applied to a part of all the channels, whereas image signals are applied to the other channels. In other words, the reproduction control system may be in the form of sound equipment, video equipment, or complex equipment (AV equipment) of the sound equipment and the video equipment.

Each of the deck area D1 and the deck area D3, which is an area as a digital player being mainly operated by a user, includes operation units such as a jog dial D11, a tempo slider D12, and at least one performance pad D13.

The jog dial D11 is a dial being operated by a user to change a rotation speed. By operating the jog dial D11, sound control information for sound processing such as scratch and pitchbend can be generated.

The tempo slider D12 is a lever for adjusting a track-reproduction speed of the music piece data stored on an optical disc inserted in the deck area D1 or the music piece data stored in the computer 3. It should be noted that the tempo slider D12 includes a built-in multicolor LED lamp (illuminator) so that a user can see an adjustment position of the tempo slider D12 to know a BPM (Beat Per Minutes) during a DJ performance.

The performance pad D13 is a button being pressed by a user to immediately perform effect processing, such as loop, cue, slicer, and sampler, on the currently reproduced music piece data. It should be noted that the performance pad D13 includes a built-in multicolor LED lamp (not shown) such that the performance pad D13 emits a different color depending on the type of effect processing.

The mixer area D2, which is an area for adjusting sound output depending on the reproduction control operation performed in the deck areas D1, D3, includes four mixing portions D21. The mixing portions D21 include two right mixing portions D21 used for adjusting sound output from the deck area D3 at the right and two left mixing portions D21 used for sound output from the deck area D1 at the left.

The mixing portions D21 each include operation units such as an effect-amount adjusting tab D22 and a volume adjusting lever D23.

The effect-amount adjusting tab D22 is a tab for adjusting an effect amount of an effect selected using a later-described effect selection button D25. A cover with a built-in multicolor LED (illuminator) is provided around the effect-amount adjusting tab D22.

The volume adjusting lever D23 is a lever for adjusting an amount of the sound output from the corresponding mixing portion D21.

A substantial center of the mixer area D2, which functions as a master mixer for adjusting the mixing portions D21 as a whole, includes a cross fader D24 and the effect selection button D25.

The cross fader D24, which is a tab for adjusting a sound output balance between the deck area D1 and the deck area D3, is moved right and left by a user to adjust the amount of the sound output from each of the deck area D1 and the deck area D3.

With use of the effect selection button D25, which is a component for adding an effect such as bandpass filter, echo, and reverb to the currently reproduced music piece, different types of effect processing can be performed depending on the mixing portions D21 of the mixer area D2. The emission of the built-in LED of the cover around the effect-amount adjusting tab D22 of each of the mixing portion D21 changes depending on the effect processing set using the effect selection button D25.

### [3] Functional Block Diagram of Sound-and-Lighting Control System 1

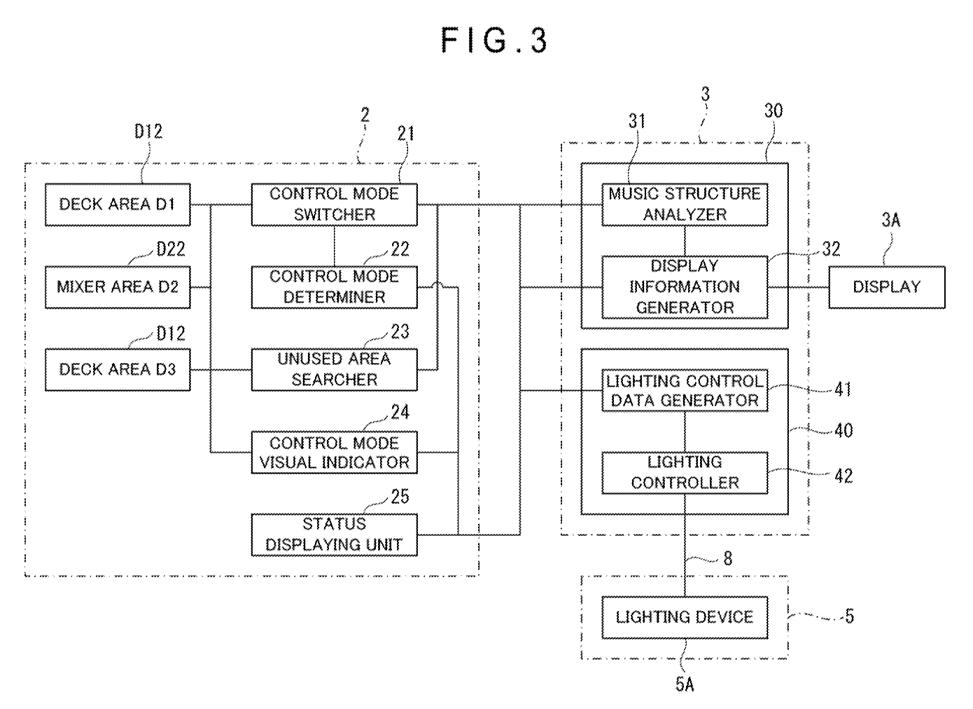

FIG. 3 shows a functional block diagram of the sound-and-lighting control system 1 according to the exemplary embodiment. The deck areas D1, D3 and the mixer area D2 of the DJ controller 2 are each controlled by a CPU configured to control the DJ controller 2. The DJ controller 2 is connected to the computer 3 through the above-described communication cable 6.

The computer 3 is also connected to the lighting fixture 5 through the communication cable 8 and a DMX interface box (not shown).

The computer 3 includes a music structure analysis unit 30 and a lighting control unit 40, each of which is in the form of a program configured to run on the CPU.

The music structure analysis unit 30 analyzes the music piece data being reproduced and displays the analysis results on a display 3A of the computer 3. The music structure analysis unit 30 includes a music structure analyzer 31 and a display information generator 32.

The music structure analyzer 31 analyzes the inputted music piece data so that characteristic sections that characterize the music structure of the music piece data are allocated on the music piece data. The characteristic sections being allocated include, for instance, an introduction section (Intro), a verse section (Verse 1), a pre-chorus section (Verse 2), a chorus section (Hook), a post-chorus section (Verse 3), and an ending section (Outro).

The music structure may be analyzed in a variety of methods. According to an exemplary method, the music structure may be analyzed by subjecting the music piece data to FFT (Fast Fourier Transform) per bar, counting the number of sounds per bar to determine transition points where transition of the characteristic sections occurs, and allocating the characteristic sections between the transition points with reference to the numbers of sounds. According to another exemplary method, the analysis may be performed by allocating the characteristic sections based on, for instance, melodic similarity in the music piece data. It should be noted that the term “the number of sounds” means the number of peaks of sound pressure level. For instance, sounds with different frequencies may be counted as different sounds, whereas fundamental tone, overtone and the like are counted as one sound (i.e., a sound of the same musical scale).

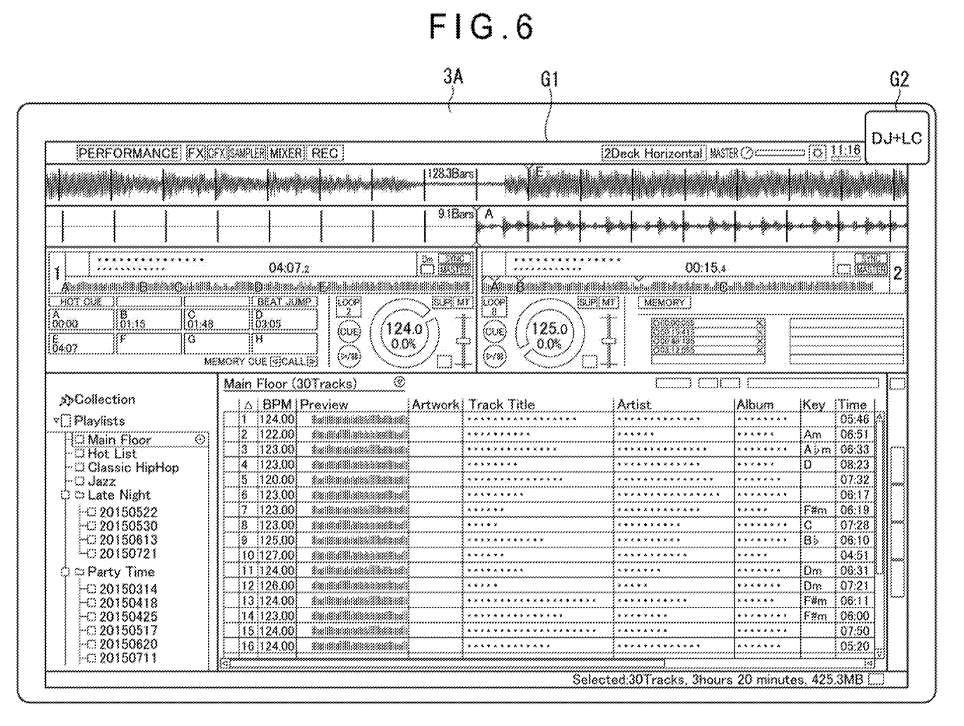

The display information generator 32 generates display information showing the progress of reproduction of the music piece based on the results of the analysis by the music structure analyzer 31 and displays the display information on the display 3A of the computer 3 (state display). The display information includes information based on the analyzed characteristic sections, such as beat information of the music piece that changes with the progress of reproduction of the music piece, sound pressure level information of the music piece, BMP of the music piece, and setting information of, for instance, effects set on the DJ controller 2 (see FIG. 6).

The lighting control unit 40 generates lighting control data based on the results of the music structure analysis by the music structure analysis unit 30 to control lighting of the lighting fixture 5.

The lighting control unit 40 includes a lighting control data generator 41 and a lighting controller 42.

The lighting control data generator 41 generates the lighting control data corresponding to the user's operation on the deck areas D1, D3 and the mixer area D2 of the DJ controller 2, which are set in a second control mode, and outputs the generated lighting control data to the lighting controller 42.

In the exemplary embodiment, the lighting control data generated by the lighting control data generator 41 is in the form of data for DMX control software, which is to be processed by the lighting controller 42. It should be noted that the lighting controller 42, which is DMX control software configured to run in the computer 3 in the exemplary embodiment, may be a hardware controller connected to the computer 3.

The lighting controller 42 controls the lighting fixture 5 based on the lighting control data outputted from the lighting control data generator 41.

The DJ controller 2 includes a control mode switcher 21, a control mode determiner 22, an unused area searcher 23, a control mode visual indicator 24, and a status displaying unit 25, which are configured to run on the CPU (Central Processing Unit) as a sound equipment control operation input program.

The control mode switcher 21 switches at least one of the plurality of deck area D1 to deck area D3 to the second control mode for controlling the lighting devices 5A of the lighting fixture 5 and switches the rest of the deck areas to a first control mode for controlling the sound equipment.

For instance, when the control mode switcher 21 sets the deck area D1 in the first control mode for sound control and the deck area D3 in the second control mode for lighting control, the tempo slider D12 of the deck area D1 is used to control the sound equipment and the tempo slider D12 of the deck area D3 is used to control the lighting equipment. It should be noted that the respective control modes of the operation units of the deck areas D1, D3 and the mixer area D2 may be set as desired. For instance, one of the four mixing portions D21 of the mixer area D2 is set as a deck area for lighting control and the effect-amount adjusting tab D22 of this mixing portion D21 is used to control the lighting equipment in some exemplary embodiments.

Meanwhile, the other mixing portions D21 are set as deck areas for sound control and the respective effect-amount adjusting tabs D22 of these mixing portions D21 are used to control the sound equipment in some exemplary embodiments.

When the deck area D3 is set in the second control mode, a control signal for lighting control is outputted by operating the deck area D3. In the exemplary embodiment, the second control mode is defined as a control mode merely for lighting control. However, the second control mode may be defined as a control mode for controlling video equipment in addition to the control mode for lighting control and further as a control mode for controlling equipment achieving stage effects such as flame and smoke in addition to the equipment for the lighting/video control.

The control mode determiner 22 determines whether the operation units of each of the deck areas D1, D3 and the mixer area D2 are set in the first control mode or the second control mode.

The unused area searcher 23 searches for an unused area in each of the deck areas D1, D3 and the mixer area D2. Specifically, one of the right mixing portions D21 of the mixer area D2 is sometimes not in use when the deck area D1 is operated for reproduction, so that the unused area searcher 23 searches for the mixing portion D21 not in use and outputs the search result to the control mode switcher 21. The control mode switcher 21 sets the one of the right mixing portions D21 in the second control mode based on the search result.

The control mode visual indicator 24 visually indicates to the user the respective control modes of the deck areas D1, D3 and of the mixing portions D21 of the mixer area D2 based on the determination results from the control mode determiner 22.

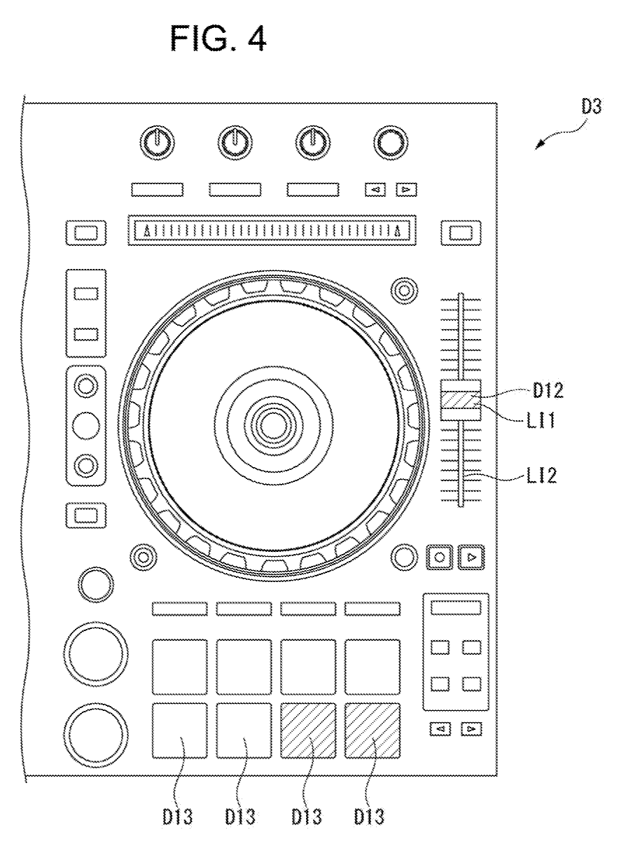

For instance, when the deck area D3 is set in the second control mode as shown in FIG. 4, the control mode visual indicator 24 changes the color of emission of the corresponding performance pad(s) D13 to be a color (e.g., yellow) different from the color of the rest of the performance pads D13 so that the lighting control mode can be easily recognized. For the other deck area D1 and mixer area D2, which are set in the first control mode for controlling the sound equipment, the control mode visual indicator 24 sets the color of emission, for instance, red or blue so that the performance pads D13 of these deck areas are easily distinguished from the performance pad(s) D13 of the deck area D3 for controlling the lighting devices 5A of the lighting fixture 5. It should be noted that the emission of the LED allows for visual recognition of the control modes in the exemplary embodiment but the invention is not limited thereto. The control modes may be distinguished in any other manner as long as the user can visually recognize the control modes.

Additionally, the control mode visual indicator 24 changes the color of emission of an LED indicator LI1 provided to a tab of the tempo slider D12 to yellow and the color of emission of an LED indicator LI2 provided to a groove of the slider to yellow as well.

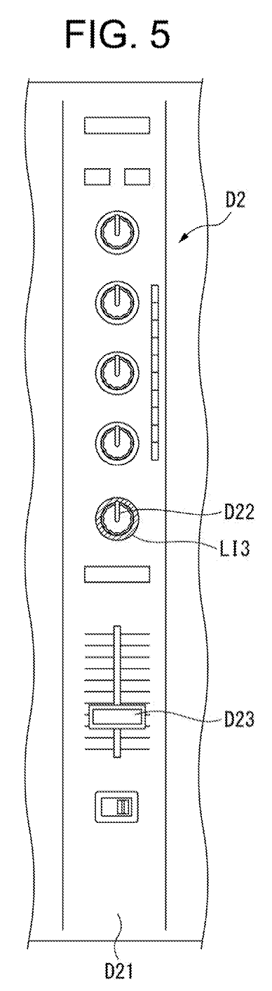

When the mixing portion(s) D21 of the mixer area D2 is set in the second control mode as shown in FIG. 5, the control mode visual indicator 24 changes the color of emission of an LED indicator LI3 around the effect-amount adjusting tab D22 to yellow.

The status displaying unit 25 displays a status showing the control mode setting of the DJ controller 2, i.e., the DJ controller 2 being merely in the first control mode or in both the first control mode and the second control mode.

For instance, when the DJ controller 2 is set in the first control mode and the second control mode, the status displaying unit 25 displays on the display 3A of the computer 3 a display image G1 showing the results of music structure analysis representing the control operation state of the sound equipment and a display image G2 (e.g., “DJ+LC”) in a superimposed manner as shown in FIG. 6. It should be noted that when the DJ controller 2 is set merely in the first control mode, a display image such as “DJ” is displayed on the display image G1 in a superimposed manner.

### [4] Advantages of Exemplary Embodiment

The above exemplary embodiment provides the following advantages.

The control mode switcher 21 of the DJ controller 2 allows the deck area D1 of the DJ controller 2 to be set in the first control mode for controlling the sound equipment and the deck area D3 to be set in the second control mode for controlling the lighting devices 5A of the lighting fixture 5. The sound equipment and the lighting fixture 5 can thus be simultaneously controlled using the DJ controller 2, achieving a DJ performance with synchronization of sound effects and lighting effect based on user's operation.

In connection with the above, the control mode determiner 22 and the control mode visual indicator 24 of the DJ controller 2 allow for changing the color of light emitted from the tempo slider D12 and/or the performance pad(s) D13 of the deck area D3 in the second control mode to yellow. Thus, the user can easily understand that the deck area D3 is intended for lighting control, which results in prevention of an erroneous operation.

Further, the unused area searcher 23 of the DJ controller 2 allows for searching for the mixing portion D21 of the mixer area D2 that is not in use so that the mixing portion D21 not in use can be set in the second control mode. The lighting control of the lighting devices 5A of the lighting fixture 5 can thus be efficiently set.

The status displaying unit 25 of the DJ controller 2 allows for displaying the display image G2, which shows whether the DJ controller 2 is set in the first control mode and the second control mode or merely in the first control mode, on the display image G1 showing the music structure analysis results. An erroneous operation can thus be prevented with higher reliability.

### EXPLANATION OF CODE(S)

1 . . . sound-and-lighting control system, 2 . . . DJ controller, 3 . . . computer, 3A . . . display, 4 . . . speaker, 5 . . . lighting fixture, 5A . . . lighting device, 6 . . . communication cable, 7 . . . analog cable, 8 . . . communication cable, 21 . . . control mode switcher, 22 . . . control mode determiner, 23 . . . unused area searcher, 24 . . . control mode visual indicator, 25 . . . status displaying unit, 30 . . . music structure analysis unit, 31 . . . music structure analyzer, 32 . . . display information generator, 40 . . . lighting control unit, 41 . . . lighting control data generator, 42 . . . lighting controller, D1 . . . deck area, D11 . . . jog dial, D12 . . . tempo slider, D13 . . . performance pad, D2 . . . mixer area, D21 . . . mixing portion, D22 . . . effect-amount adjusting tab, D23 . . . volume adjusting lever, D24 . . . cross fader, D25 . . . effect selection button, D3 . . . deck area, G1 . . . display image, G2 . . . display image, LI1 . . . LED indicator, LI2 . . . LED indicator, LI3 . . . LED indicator

1. A sound equipment control operation input device comprising:
a plurality of operation units, at least one of the operation units being operated to control sound equipment;
a control mode switcher configured to switch one or more of the operation units to a first control mode for controlling the sound equipment or a second control mode for controlling lighting equipment;
a control mode determiner configured to determine respective control mode settings of the operation units; and
a control mode visual indicator configured to visually indicate the respective control mode settings of the operation units based on results of determination by the control mode determiner.

2. The sound equipment control operation input device according to claim 1, wherein video equipment is further controllable in the second control mode.

3. The sound equipment control operation input device according to claim 1, wherein equipment for providing stage effects with flame and smoke is further controllable in the second control mode.

4. The sound equipment control operation input device according to claim 1, wherein
the operation units each comprise an illuminator, and
the control mode visual indicator is configured to change emission of the illuminator.

5. The sound equipment control operation input device according to claim 1, further comprising:
a state display configured to display a control operation state of the sound equipment; and
a status displaying unit configured to display on the state display a status where merely the first control mode is set or both the first and second control modes are set.

6. The sound equipment control operation input device according to claim 1, further comprising an unused area searcher configured to search for one of the operation units that is not in use, wherein the control mode switcher is configured to switch the operation unit that is not in use searched for by the unused area searcher to the second control mode.

7. A computer-readable medium stored with a program code, the program code being configured to, when read and executed by a computer, enable the computer to function as the sound equipment control operation input device according to claim 1.
